(19) United States
(12) Patent Application Publication
(10) Pub. No.: US 2023/0208922 A1
(43) Pub. Date: Jun. 29, 2023

(54) COMMUNICATION SYSTEM, MANAGEMENT SERVER, AND NON-TRANSITORY COMPUTER-EXECUTABLE MEDIUM

(71) Applicant: Kazumasa Takemura, Kanagawa (JP)

(72) Inventor: Kazumasa Takemura, Kanagawa (JP)

(73) Assignee: Ricoh Company, Ltd., Tokyo (JP)

(21) Appl. No.: 18/061,113

(22) Filed: Dec. 2, 2022

(30) Foreign Application Priority Data
Dec. 27, 2021 (JP) 2021-213235

(51) Int. Cl. H04L 67/141; H04L 47/12; H04L 67/566

(52) U.S. Cl. CPC H04L 67/141; H04L 47/12; H04L 67/566

(57) ABSTRACT

A communication system includes circuitry. The circuitry receives a use request for using a service provided by an information processing apparatus that resides in a local network, from a terminal apparatus connected to an external network external to the local network. According to the use request, the circuitry selects, from among multiple communication apparatuses that reside on the local network and support the service, particular one communication apparatus having a lower load than other communication apparatuses. The circuitry instructs the terminal apparatus and the particular one communication apparatus to each connect to a relay server on the external network.

### CROSS-REFERENCE TO RELATED APPLICATION

This patent application is based on and claims priority pursuant to 35 U.S.C. § 119(a) to Japanese Patent Application No. 2021-213235, filed on Dec. 27, 2021, in the Japan Patent Office, the entire disclosure of which is hereby incorporated by reference herein.

### BACKGROUND

### Technical Field

The present disclosure relates to a communication system, a management server, and a non-transitory computer-executable medium.

### Related Art

Current spread of work style reform and work from home increases need for remote access that allows terminal apparatuses or the like connected to an external network to use services provided by information processing apparatuses in a local network.

For example, virtual desktop systems are known that include a virtual desktop management apparatus for remote connection, a virtualization server, a network processing apparatus, and one or more thin client terminals.

### SUMMARY

An embodiment of the present disclosure includes a communication system including circuitry. The circuitry receives a use request for using a service provided by an information processing apparatus that resides in a local network, from a terminal apparatus connected to an external network external to the local network. According to the use request, the circuitry selects, from among multiple communication apparatuses that reside on the local network and support the service, particular one communication apparatus having a lower load than other communication apparatuses. The circuitry instructs the terminal apparatus and the particular one communication apparatus to each connect to a relay server on the external network.

An embodiment of the present disclosure includes a management server including circuitry. The circuitry receives, from a terminal apparatus connected to an external network external to a local network, a use request for using a service provided by an information processing apparatus that resides in the local network, the service being used by the terminal apparatus via a communication apparatus that resides in the local network. According to the use request, the circuitry selects, from among multiple communication apparatuses that reside on the local network and support the service, particular one communication apparatus having a lower load than other communication apparatuses. The circuitry instructs the terminal apparatus and the particular one communication apparatus to each connect to a relay server on the external network.

An embodiment of the present disclosure includes a non-transitory computer-executable medium storing a program storing instructions which, when executed by one or more processors of a computer that controls communication, causes the one or more processors to perform a method. The method includes receiving, from a terminal apparatus connected to an external network external to a local network, a use request for using a service provided by an information processing apparatus that resides in the local network, the service being used by the terminal apparatus via a communication apparatus that resides in the local network. The method includes, according to the use request, selecting, from among multiple communication apparatuses that reside on the local network and support the service, particular one communication apparatus having a lower load than other communication apparatuses. The method includes instructing the terminal apparatus and the particular one communication apparatus to each connect to a relay server on the external network.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an example of a configuration of a communication system, according to an embodiment of the present disclosure;

FIG. 2 is a block diagram illustrating an example of a hardware configuration of a computer, according to an embodiment of the present disclosure;

FIG. 3 is a block diagram illustrating an example of a functional configuration of the communication system, according to an embodiment of the present disclosure;

FIG. 4A, FIG. 4B, and FIG. 4C are diagrams each illustrating an example of information managed by a management server, according to an embodiment of the present disclosure;

FIG. 5 is a block diagram illustrating an example of a functional configuration of a communication apparatus, according to an embodiment of the present disclosure;

FIG. 6 is a sequence diagram illustrating an example of an operation performed by the communication system, according to an embodiment of the present disclosure;

FIG. 7 is a sequence diagram illustrating an example of an operation performed by the communication system, according to an embodiment of the present disclosure;

FIG. 8 is a sequence diagram illustrating an example of an operation performed by the communication system, according to an embodiment of the present disclosure;

FIG. 9 is a sequence diagram illustrating an example of an operation of selecting a particular communication apparatus, according to a first embodiment of the present disclosure;

FIG. 10 is a sequence diagram illustrating an example of an operation of selecting a particular communication apparatus, according to a second embodiment of the present disclosure;

FIG. 11 is a flowchart illustrating an example of an operation of selecting a particular communication apparatus, according to a third embodiment of the present disclosure;

FIG. 12 is a flowchart illustrating an example of an operation of selecting a particular communication apparatus, according to a fourth embodiment of the present disclosure;

FIG. 13 is a flowchart illustrating an example of an operation of registering a communication apparatus, according to an embodiment of the present disclosure;

FIG. 14 is a diagram illustrating an example of a registration screen, according to an embodiment of the present disclosure;

FIG. 15 is a diagram illustrating an example of a registration screen, according to an embodiment of the present disclosure; and

FIG. 16 is a diagram illustrating an example of a registration screen, according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to the drawings, embodiments of the present disclosure are described.

System Configuration

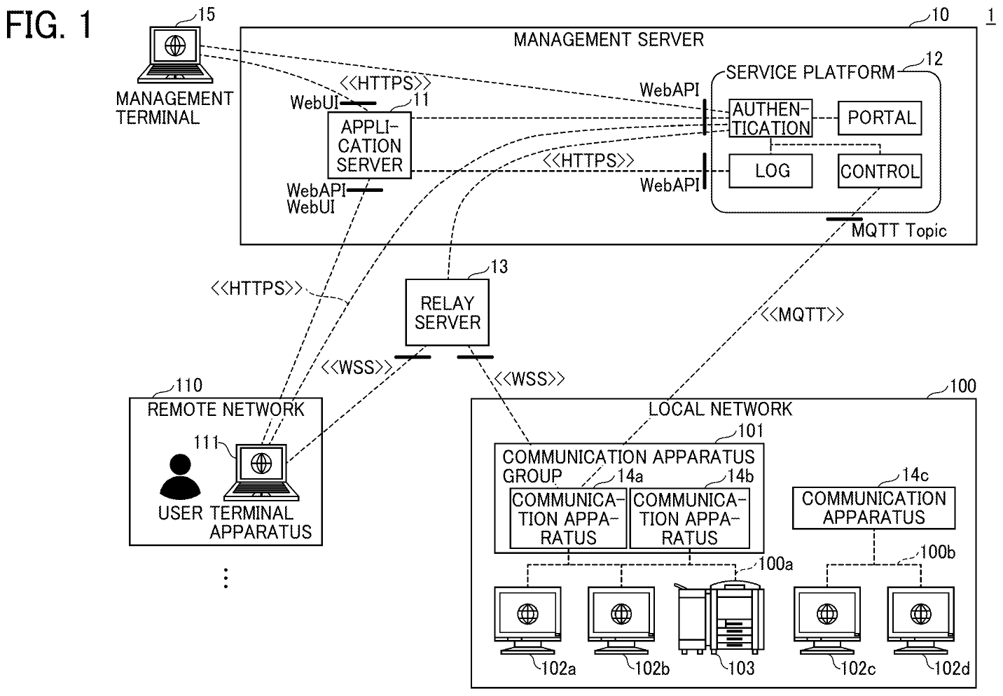

FIG. 1 is a schematic diagram illustrating an example of a configuration of a communication system 1 according to a first embodiment of the present disclosure. The communication system 1 includes, for example, an application server 11, a service platform 12, and a relay server 13, each being connected to a communication network such as the Internet, and multiple communication apparatuses including a communication apparatus 14a, a communication apparatus 14b, and a communication apparatus 14c, connected to a local network 100. In the following description, any one or more of the multiple communication apparatuses including the communication apparatus 14a, the communication apparatus 14b, and the communication apparatus 14c may be referred to as a “communication apparatus 14” or “communication apparatuses 14.”

The communication network includes various networks including, for example, a wide area network (WAN) such as the Internet and a mobile communication network, and a local area network (LAN) other than the local network 100. In another example, the communication network includes a network by not only wired communications but also a network by wireless communications such as 3rd generation (3G), 4th generation (4G), 5th generation (5G), Wireless Fidelity (Wi-Fi®), Worldwide Interoperability for Microwave Access (WiMAX) or Long Term Evolution (LTE).

The communication system 1 further includes a terminal apparatus 111 and a management terminal 15, each being connected to a network outside the local network 100. In the following description, the network outside the local network 100 may be referred to as an “external network.” In the example of FIG. 1, the terminal apparatus 111 is connected to a remote network 110, which is an example of the external network.

Examples of the remote network 110 include, but are not limited to, a LAN and a private network, which is provided at a home or a remote office and which is connected to the communication network such as the internet. In alternative to the remote network 110, the terminal apparatus 111 may connect to the communication network such as the Internet using the WAN or a public wireless LAN from a remote place away from home or the remote office. In the embodiment, the following description is given of an example in which terminal apparatus 111 is connected to the remote network 110 provided in the remote office or the like, and the communication network is the internet.

The communication system 1 is a system in the terminal apparatus 111 connected to the external network uses services provided by an information processing apparatus such as an information processing apparatus 102 or an image forming apparatus 103 connected to the local network 100.

The terminal apparatus 111 is a computer having a web browser function, such as a personal computer (PC), a tablet terminal, or a smartphone, used by a user.

The terminal apparatus 111 accesses the application server 11 and the relay server 13 through the remote network 110 and the communication network.

The local network 100 is a network of, for example, companies, educational institutions, medical institutions, to which access from an external network is restricted by, for example, a firewall. By contrast, access from the communication apparatus 14 in the local network 100 to the relay server 13 and the service platform 12 on the external network is permitted.

In the example of FIG. 1, the local network 100 includes a first local network 100a and a second local network 100b. FIG. 1 illustrates an example in which the communication apparatus 14a, the communication apparatus 14b, an information processing apparatus 102a, the information processing apparatus 102b, and the image forming apparatus 103 are connected to the first local network 100a. Further, FIG. 1 illustrates an example in which the communication apparatus 14c, an information processing apparatus 102c, and an information processing apparatus 102d are connected to the second local network 100b.

In the following description, any arbitrary one or more of the information processing apparatus 102a to the information processing apparatus 102d may be collectively referred to as the “information processing apparatus 102”, to simplify the description.

In FIG. 1, it is assumed that the service platform 12 and the communication apparatus 14 are set to be communicable in compliance with, for example, a Message Queue Telemetry Transport (MQTT) protocol. For example, the communication apparatus 14 accesses the service platform 12 at startup, to establish and maintain MQTT communication.

Access to the communication apparatus 14, the information processing apparatus 102, the image forming apparatus 103 in the local network 100 from the terminal apparatus 111 and the relay server 13 is prohibited.

The information processing apparatus 102 is a computer such as a PC connected to the local network 100. The information processing apparatus provides a service such as a remote desktop service. The image forming apparatus 103 is an electronic device connected to the local network 100 and provides a service such as a facsimile service.

The information processing apparatus 102 and the image forming apparatus 103 are each an example of an information processing apparatus that is connected to the local network 100 and provides a service. Other examples of the information processing apparatus include, but are not limited to, a projector (PJ), an interactive white board (IWB), which is an electronical whiteboard with mutual communication capability, and a digital signage. Still other examples of the information processing apparatus include, but are not limited to, an industrial machine, an imaging device, an audio collecting device, a networked home appliance, a smartphone, a tablet terminal, a game console, a personal digital assistant (PDA), and a digital camera. In the embodiment, a description is given of an example in which a user who uses the terminal apparatus 111 uses the remote desktop service provided by the information processing apparatus 102 in the local network 100.

The application server 11 is, for example, an information processing apparatus having a configuration of a computer or a system including multiple information processing apparatuses. The application server 11 has a function of a web server that provides, to the terminal apparatus 111, web contents for using a service provided by the information processing apparatus 102 or the image forming apparatus 103 in the local network 100, for example, by using the communication system 1. Further, the application server 11 has a function of providing a web page for configuring settings of the communication system 1 to the management terminal 15, which is an information terminal used by, for example, an administrator or an auditor who manages the communication system 1.

The service platform 12 is, for example, an information processing apparatus having a configuration of a computer or a system including multiple information processing apparatuses. The service platform 12 has, for example, an authentication function of authenticating the communication apparatus 14, the terminal apparatus 111, or the management terminal 15, a log function of acquiring a log, a portal function of providing a portal screen, and a control function of controlling the communication apparatus 14.

The relay server 13 is, for example, an information processing apparatus having a configuration of a computer or a system including multiple information processing apparatuses. The relay server 13 relays communication between the terminal apparatus 111 and the communication apparatus 14.

The application server 11 and the service platform 12 configure a management server 10 that provides a remote access service to the terminal apparatus 111, for example. In one example, one server apparatus implements functions of the application server 11 and the service platform 12. In another example, functions of the application server 11 and the service platform 12 are distributed over two or more server apparatuses. Since the application server 11 and the service platform 12 can have various system configurations in this manner, in the following description, the application server 11 and the service platform 12 may be simply referred to as the “management server 10”, unless they need to be distinguished from each other.

The communication apparatus 14 is a computer having a communication capability. The communication apparatus 14 connects to the relay server 13 according to an instruction from the management server 10, and relays communication between the relay server 13 and the service provided by the information processing apparatus in the local network 100.

The management terminal 15 is, for example, an information terminal having a web browser function and used by an administrator or the like who manages the communication system 1. For example, the administrator or the like uses the management terminal 15 to access a web page provided by the management server 10 to configure settings of the management server 10.

Overview of Connection Processing

In the system configuration as described above, a user who uses the terminal apparatus 111 accesses a web page provided by the management server 10 using a web browser or the like, to use, for example, the remote desktop service provided by the information processing apparatus 102. The user selects a desired service from the web page, to request connection to the remote desktop service provided by the information processing apparatus 102, for example. The web browser of the terminal apparatus 111 is merely one example used for accessing the web page. In another example, the user may access the web page using an application program for communication system 1. In the following description, the application program may be referred to as an “application.”

In response to receiving the connection request from the terminal apparatus 111, the management server 10 generates (issues) a session identifier (ID), which is identification information identifying a session. Further, the management server 10 notifies the communication apparatus 14 of the generated session ID and requests connection to the relay server 13. Furthermore, the application server 11 notifies the terminal apparatus 111 as a request source of the issued session ID.

The communication apparatus 14 connects to the relay server 13 according to the request from the management server 10 using the notified session ID. For example, the communication apparatus 14 establishes a session with the relay server 13 using web socket over hypertext transfer protocol secure (HTTPS). In the following description, the web socket over HTTPS may be referred to as “WSS.”

The terminal apparatus 111 connects to the relay server 13 using the session ID notified from the management server 10. For example, the terminal apparatus 111 establishes a session with the relay server 13 using WSS.

The relay server 13 controls the terminal apparatus 111 and the communication apparatus 14, which have established a session with the relay server 13 using the same session ID (identification information), to participate in the same session, and relays communication between the terminal apparatus 111 and the communication apparatus 14. For example, the relay server 13 tunnels communication with the terminal apparatus 111 and communication with the communication apparatus 14, to connect the terminal apparatus 111 and the communication apparatus 14 with each other so that they are communicable with each other.

Through the above processing, the terminal apparatus 111 connects to the communication apparatus 14 using WSS. Further, since the communication apparatus 14 relays communication between the relay server 13 and the information processing apparatus 102 according to an instruction from the management server 10, the terminal apparatus 111 can use the remote desktop service provided by the information processing apparatus 102.

In the communication system 1 according to the present embodiment, for example, in a case that the number of users who use remote access increases and the load on the communication apparatus 14 increases, the load on the communication apparatus 14 can be reduced by adding the communication apparatus 14 as illustrated in FIG. 1. For example, when the load on the communication apparatus 14a that relays the remote desktop service provided by the information processing apparatus 102a and the information processing apparatus 102b increases, the administrator or the like adds the communication apparatus 14b.

However, with only this configuration, for example, a situation may occur in which a large number of terminal apparatuses 111 connect to the communication apparatus 14a and no terminal apparatus 111 connects to the communication apparatus 14b. For example, there may be an issue that connections are concentrated on the communication apparatus 14b and other connection destinations registered in the communication apparatus 14a cannot be used even though there is spare capacity in the number of available sessions provided by the communication apparatus 14a, and thus an increase in the number of users is not efficiently handled.

To address such an issue, in the present embodiment, for example, multiple communication apparatuses (e.g., the communication apparatus 14a and the communication apparatus 14b) that support the remote desktop service provided by the information processing apparatus 102a are registered in advance in the management server 10 as a communication apparatus group 101.

In response to receiving a use request for using the remote desktop service provided by the information processing apparatus 102a from the terminal apparatus 111, the management server 10 selects a particular one of the communication apparatuses 14 having a lower load than the other communication apparatuses 14 from among the communication apparatus 14a and the communication apparatus 14b that support the remote desktop service.

The management server 10 instructs the selected particular one of the communication apparatuses 14 and the terminal apparatus 111 to connect to the relay server 13.

Through the processing as described above, according to the present embodiment, in the communication system 1 in which the terminal apparatus 111 connected to the external network uses a service provided by the information processing apparatus 102 in the local network 100, an increase in the number of users is efficiently handled.

The system configuration of the communication system 1 illustrated in FIG. 1 is merely one example. For example, in the example of FIG. 1, the local network 100 is connected to the external network via the communication apparatus 14. However, this is merely an example. In another example, the local network 100 may be connected to the external network via a router and a firewall. In this case, the communication apparatus 14 communicates with the service platform 12 and the relay server 13 via the router and the firewall.

The communication apparatus 14 may be a server apparatus having a communication capability and executing a program.

Hardware Configuration

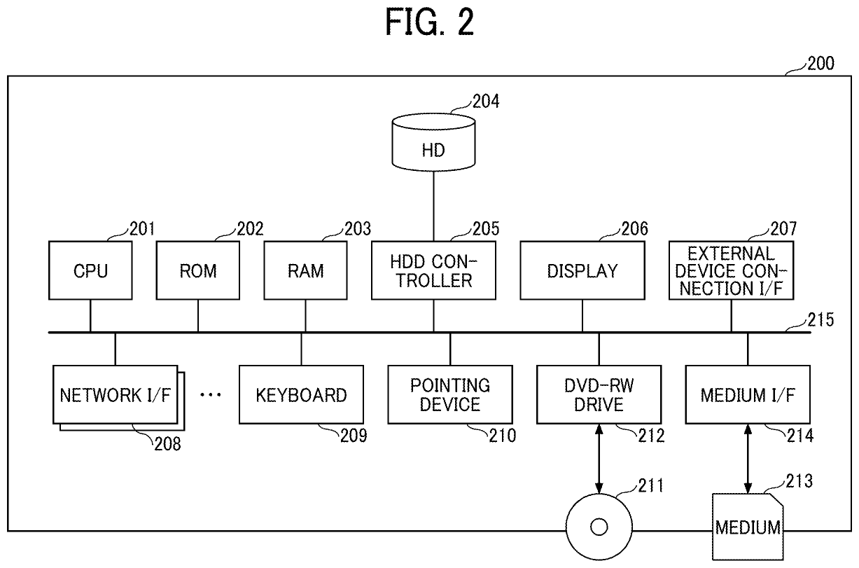

Each of the terminal apparatus 111, the information processing apparatus 102, and the management terminal 15 includes, for example, a hardware configuration of a computer 200 as illustrated in FIG. 2. The application server 11, the service platform 12, the relay server 13, and the management server 10 are implemented by one or more computers 200.

FIG. 2 is a block diagram illustrating an example of a hardware configuration of the computer 200, according to an embodiment. As illustrated in FIG. 2, the computer 200 includes, for example, a central processing unit (CPU) 201, a read only memory (ROM) 202, a random access memory (RAM) 203, a hard disk (HD) 204, a hard disk drive (HDD) controller 205, a display 206, an external device connection interface (I/F) 207, one or more network I/Fs 208, a keyboard 209, a pointing device 210, a digital versatile disk rewritable (DVD-RW) drive 212, a medium I/F 214, and a bus line 215.

The CPU 201 is a processor that controls overall operation of the computer 200. The ROM 202 stores a program such as an initial program loader (IPL) to boot the computer 200. The RAM 203 is used as, for example, a work area for the CPU 201. The HD 204 stores, for example, programs such as an operating system (OS), an application, and a device driver, and various data. The HDD controller 205 controls, for example, reading or writing of various data to and from the HD 204 under control of the CPU 201.

The display 206 displays various information such as a cursor, a menu, a window, a character, or an image. The display 206 may be external to the computer 200. The external device connection I/F 207 is an interface for connecting an external device to the computer 200. One or more network I/Fs 208 are interfaces for data communication using, for example, the communication network, the local network 100, or the remote network 110.

The keyboard 209 is an example of an input device provided with a plurality of keys that allows a user to input characters, numerals, or various instructions. The pointing device 210 is an example of an input device that allows a user to select or execute a specific instruction, select an item to be processed, or move a cursor being displayed. The keyboard 209 and the pointing device 210 may be external to the computer 200.

The DVD-RW drive 212 controls reading and writing of various data from and to a DVD-RW 211, which is an example of a removable storage medium. The DVD-RW 211 is merely one example of the removable storage medium. In another example, a digital versatile disk recordable (DVD-R) may be used as the removable storage medium. The medium I/F 214 controls reading and writing (storing) of data from and to a storage medium 213 such as a flash memory. The bus line 215 includes an address bus and a data bus. The bus line 215 electrically connects the above-described hardware components to each other and transmits various control signals.

The configuration of the computer 200 illustrated in FIG. 2 is merely one example. The computer 200 may have any other suitable configuration, provided that the computer includes, for example, the CPU 201, the ROM 202, the RAM 203, one or more network I/Fs 208, and the bus line 215. Further, the electronic device such as the image forming apparatus 103 may have any suitable configuration, provided that the electronic device has a communication capability and a configuration of the computer.

Functional Configuration

A functional configuration of each of the apparatuses and devices relating to the communication system 1 is described. Since the management terminal 15 is a general-purpose computer having a function of a web browser, description thereof is omitted below.

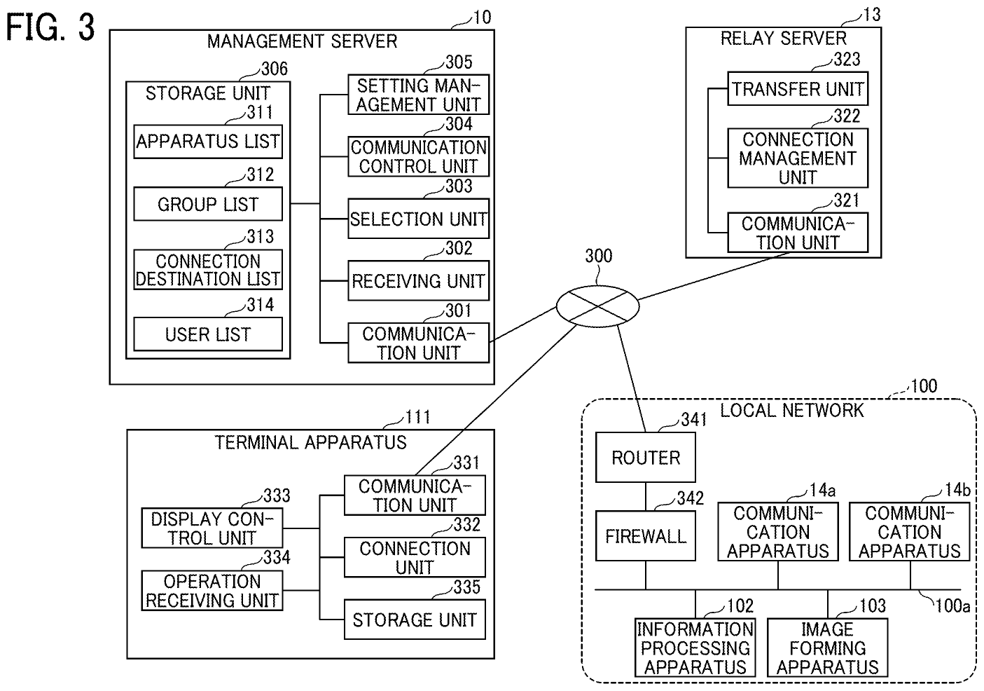

FIG. 3 is a block diagram illustrating an example of a functional configuration of the communication system 1, according to an embodiment. In the following, a description is provided on the assumption that the communication apparatus 14a and the communication apparatus 14b are connected to the first local network 100a in the local network 100, and the management server 10, the relay server 13, and the terminal apparatus 111 are connected to a communication network 300, which is an example of the external network. The communication network 300 may include various networks such as the remote network 110, the Internet, a wireless WAN, and a LAN.

Functional Configuration of Management Server

The management server 10 includes a communication unit 301, a receiving unit 302, a selection unit 303, a communication control unit 304, a setting management unit 305, and a storage unit 306, each being implemented by executing a predetermined program by one or more computers 200. In another example, at least a part of the functional units is implemented by hardware.

The communication unit 301 connects the management server 10 to the communication network 300 using, for example, the network I/F 208, and performs communication processing of communicating with the communication apparatus 14, the relay server 13, the terminal apparatus 111, or the management terminal 15.

The receiving unit 302 performs reception processing of receiving a use request that requests to use a service provided by the information processing apparatus 102 (or the image forming apparatus 103) from, for example, the terminal apparatus 111.

In response to the use request received by the receiving unit 302, the selection unit 303 performs selection processing of selecting a particular one communication apparatus having a lower load than the other communication apparatuses from among multiple communication apparatuses 14 (e.g., the communication apparatus 14a and the communication apparatus 14b) that support the requested service.

Preferably, the selection unit 303 selects the particular one communication apparatus on the basis of information on resources used or available by each of the plurality of communication apparatuses 14 that support the requested service.

The communication control unit 304 performs communication control processing of instructing the terminal apparatus 111 that has transmitted the use request and the particular one communication apparatus selected by the selection unit 303 to connect to the relay server 13. For example, the communication control unit 304 transmits, to the particular one communication apparatus 14 and the terminal apparatus 111, a connection instruction that instructs to connect to the relay server 13, the connection instruction including identification information for identifying a session. In the following description, the identification information for identifying the session may be referred to as a “session ID.”

The setting management unit 305 provides the management terminal 15 with a web page for displaying a setting screen for managing settings of the communication system 1 or a web application programming interface (API), and performs setting management processing of managing the set information. For example, the setting management unit 305 stores an apparatus list 311, a group list 312, a connection destination list 313, and a user list 314 in the storage unit 306 and manages the stored lists.

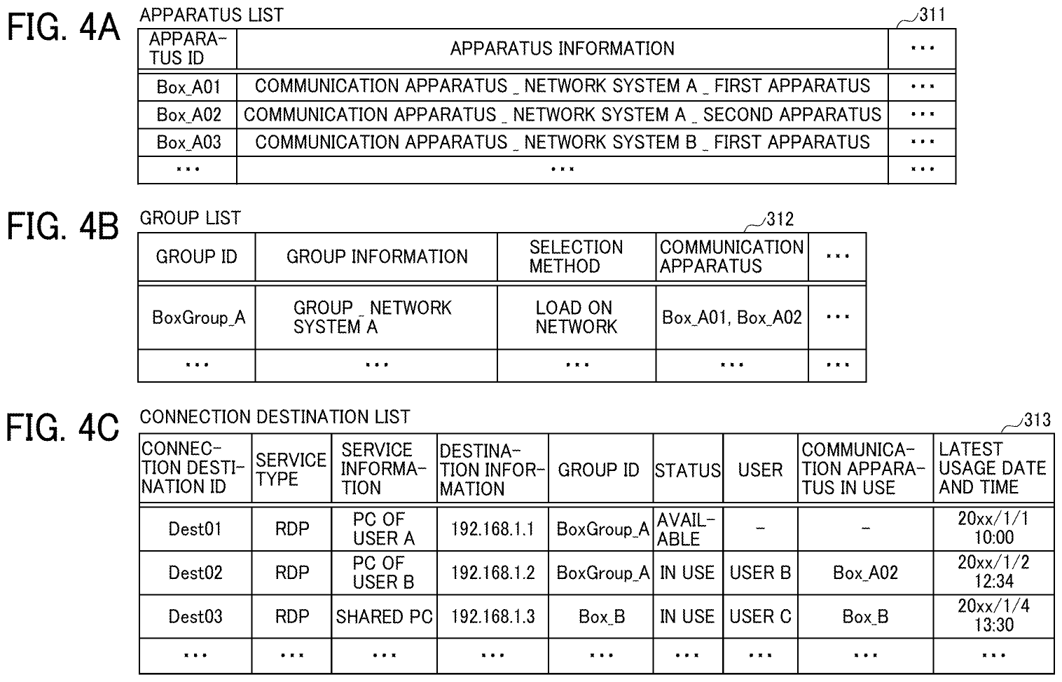

FIG. 4A is a table of an example of the apparatus list 311 managed by the setting management unit 305. In the apparatus list 311, an apparatus ID and apparatus information are registered in association with other. The apparatus ID is identification information for identifying the communication apparatus 14 registered in the communication system 1. The apparatus information includes, for example, a display name of the corresponding communication apparatus 14. In another example, in the apparatus list 311, authentication information for authenticating the communication apparatus 14 that requests the management server 10 to establish an MQTT connection may be further registered.

FIG. 4B is a table of an example of the group list 312 managed by the setting management unit 305. In the example of FIG. 4B, in the group list 312, information such as “group ID”, “group information”, “selection method”, and “communication apparatus” is registered as items.

The “group ID” is identification information for identifying the communication apparatus group 101, which is a group of the communication apparatuses 14 supporting a service provided by the information processing apparatus 102. The “group information” includes, for example, a display name of the communication apparatus group 101. The “selection method” is information specifying a selection method by which the selection unit 303 selects the particular one communication apparatus having a lower load than the other communication apparatuses from multiple communication apparatuses 14 supporting the requested service. The “communication apparatus” includes a list of apparatus IDs of the communication apparatuses 14 registered in the communication apparatus group 101.

FIG. 4C is a table of an example of the connection destination list 313 managed by the setting management unit 305. In the example of FIG. 4C, in the connection destination list 313, information such as “connection destination ID”, “service type”, “service information”, “destination information”, “group ID”, “status”, “user”, “communication apparatus in use”, and “latest usage date and time” is registered as items.

The “connection destination ID” is identification information for identifying an information processing apparatus (connection destination) such as the information processing apparatus 102 or the image forming apparatus 103 that provides a service in the local network. The “service type” is information indicating a type of service provided by the information processing apparatus (connection destination).

For example, a service type “remote desktop protocol (RDP)” indicates a remote desktop service provided by the information processing apparatus 102. A service type “FAX” indicates a facsimile service provided by the image forming apparatus 103. The “service information” is information indicating, for example, a display name of each service. The “destination information” is information such as an internet protocol (IP) address or a uniform resource locator (URL) for connecting to an information processing apparatus that provides the service such as the information processing apparatus 102 that provides the service or the image forming apparatus 103.

The “group ID” is a group ID for identifying the communication apparatus group 101 that supports the service. The “status” is information indicating a status of the service, such as available or in use. The “user” is information such as a name of a user who is using the service. The “communication apparatus in use” is the apparatus ID for identifying the communication apparatus 14 being used by the service. The “latest usage date and time” is information indicating the date and time when the service was last used.

Referring again to FIG. 3, the description of the functional configuration of the management server 10 is continued. The storage unit 306 is implemented by, for example, a program executed by the CPU 201, the HD 204, and the HDD controller 205. The storage unit 306 stores various information such as the apparatus list 311, the group list 312, the connection destination list 313, and the user list 314. In the user list 314, a user ID, authentication information, a display name, and the like of each user or administrator registered in the communication system 1 are registered in advance.

Functional Configuration of Relay Server

The relay server 13 includes a communication unit 321, a connection management unit 322, and a transfer unit 323, each being implemented by executing a predetermined program by one or more computers 200. In another example, at least a part of the functional units is implemented by hardware.

The communication unit 321 connects the relay server 13 to the communication network 300 using, for example, the network I/F 208, and performs communication processing of communicating with the terminal apparatus 111, the communication apparatus 14, and the management server 10.

The connection management unit 322 performs connection management processing of managing connection to the relay server 13 of the terminal apparatus 111 and the communication apparatus 14 that request connection to the relay server 13. For example, the connection management unit 322 controls the terminal apparatus 111 and the communication apparatus 14 that request connection to the relay server 13 using the same session ID to participate in the same session.

The transfer unit 323 performs transfer processing of transferring (relaying) communication between the terminal apparatus 111 and the communication apparatus 14 participating in the same session. For example, the transfer unit 323 transfers data transmitted by the terminal apparatus 111 to the communication apparatus 14, and transfers data transmitted by the communication apparatus 14 to the terminal apparatus 111.

Functional Configuration of Terminal Apparatus

The terminal apparatus 111 includes a communication unit 331, a connection unit 332, a display control unit 333, an operation receiving unit 334, and a storage unit 335, each being implemented by executing a predetermined program by the CPU 201. In another example, at least a part of the functional units is implemented by hardware.

The communication unit 331 connects the terminal apparatus 111 to the communication network 300 using, for example, the network I/F 208, and performs communication processing of communicating with the management server 10 and the relay server 13.

The connection unit 332 performs connection processing of connecting to the relay server 13 by, for example, using the session ID (identification information) notified from the management server 10 and establishing a session.

The display control unit 333 performs display control processing of controlling a display unit such as the display 206 to display a display screen transmitted from the management server 10, or the communication apparatus 14. Examples of the display screen include, but are not limited to, a web user interface (UI) and a hyper text markup language (HTML) screen. The display control unit 333 also controls reproduction of audio when the display screen includes audio data.

The operation receiving unit 334 receives an operation by a user (or an administrator) on the display screen displayed by the display control unit 333.

The storage unit 335 is implemented by, for example, a program executed by the CPU 201, the HD 204, and the HDD controller 205. The storage unit 335 stores various information or data.

Functional Configuration of Communication Apparatus

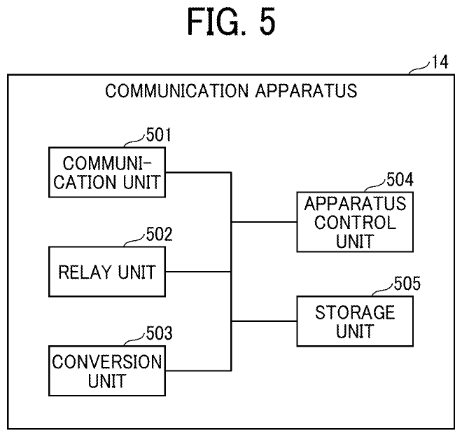

FIG. 5 is a block diagram illustrating an example of a functional configuration of the communication apparatus 14 according to an embodiment. The communication apparatus 14 includes a communication unit 501, a relay unit 502, a conversion unit 503, an apparatus control unit 504, and a storage unit 505, each being implemented by executing a predetermined program by the CPU 201. In another example, at least a part of the functional units is implemented by hardware.

The communication unit 501 connects the communication apparatus 14 to the local network 100 using, for example, the network I/F 208 and performs communication processing of communicating with another apparatus.

The relay unit 502 connects to the relay server 13 from within the local network 100 according to an instruction from the management server 10, and performs relay processing of relaying communication between the relay server 13 and the information processing apparatus that provides a service within the local network 100.

When a protocol for transmitting and receiving data to and from the relay server 13 and a protocol for transmitting and receiving data to and from information processing apparatus that provides a service are different from each other, the conversion unit 503 performs conversion processing of mutually converting the protocols. For example, the conversion unit 503 mutually converts the WSS protocol used for transmitting and receiving data by the terminal apparatus 111 and the RDP protocol used for transmitting and receiving data by the information processing apparatus 102 that provides a service. In another example, the relay server 13 may include the conversion unit 503.

For example, the apparatus control unit 504 performs apparatus control processing of requesting the management server 10 to establish a connection at startup using the MQTT protocol or the like to establish communication and maintaining a communicable state with the management server 10. The apparatus control unit 504 further has a function of measuring, for example, a communication bandwidth available by the communication apparatus 14 or a usage rate of a resource such as a CPU or a memory in response to a request from the management server 10 and transmitting a measurement result to the management server 10.

The storage unit 505 is implemented by a program executed by, for example, the CPU 201, the HD 204, and the HDD controller 205. The storage unit 505 stores various information such as setting information of the communication apparatus 14.

The functional configuration of the communication system 1 illustrated in FIG. 3 is an example. For example, the functional units of the management server 10 may be distributed over multiple server apparatuses. In another example, the management server 10 may include at least part of the functional units of the relay server 13. In substantially the same manner, the relay server 13 may include at least part of the functional units of the management server 10.

Operation

A description is now given of a processing flow of a communication control method according to the present embodiment.

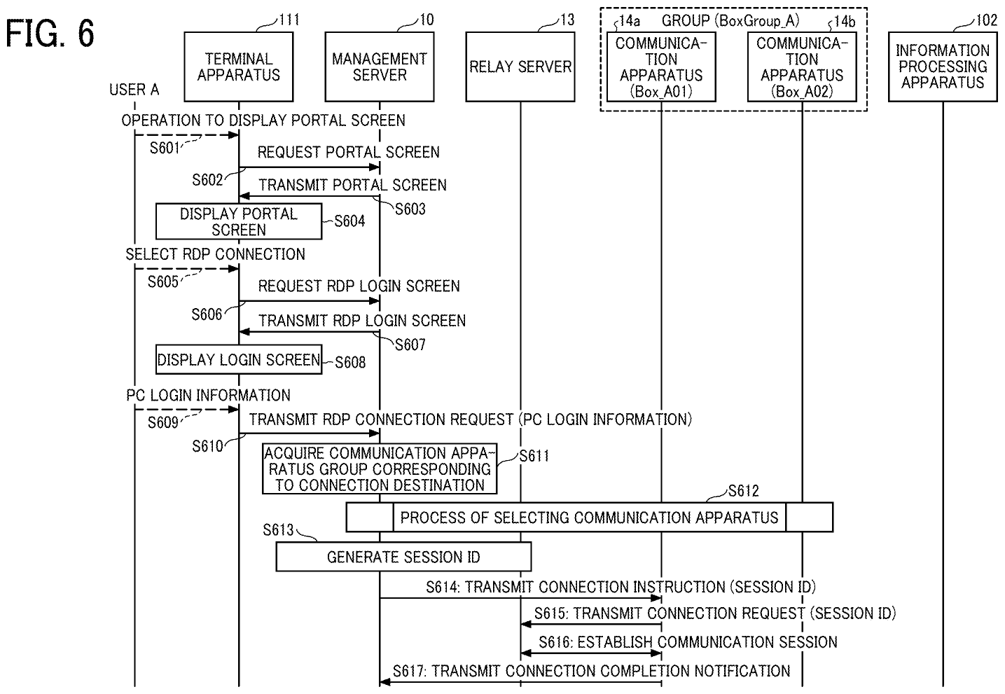

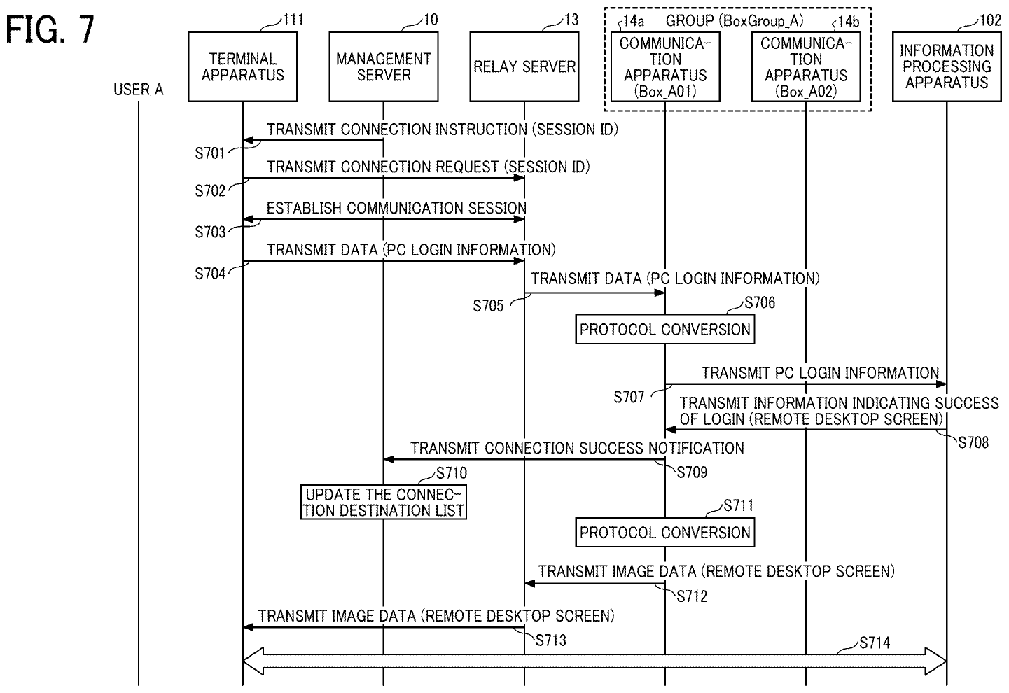

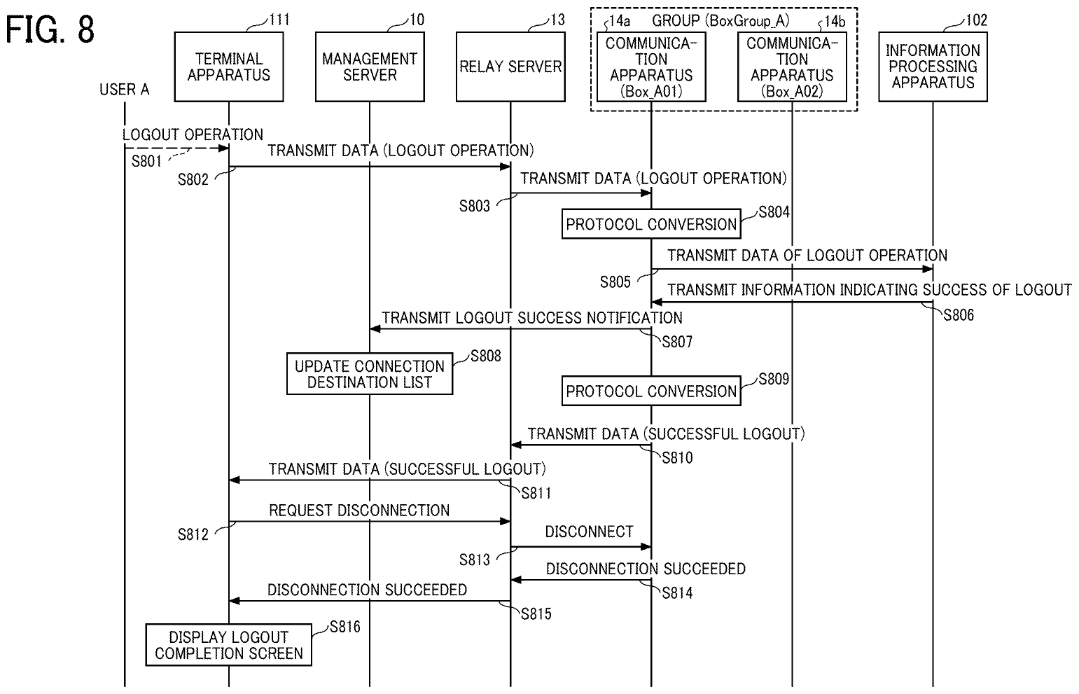

Operation of Communication System FIG. 6, FIG. 7, and FIG. 8 are sequence diagrams illustrating an example of an operation performed by the communication system 1, according to an embodiment. The operation is an example of an operation performed by the communication system 1 in the case the terminal apparatus 111 uses the remote desktop service provided by the information processing apparatus 102 within the local network 100. It is assumed that the terminal apparatus 111 has already logged in to the management server 10 at the start of the operation illustrated in FIG. 6.

In response to an operation for displaying a portal screen by User A on the terminal apparatus 111 in step S601, the communication system 1 performs processes of step S602 and subsequent processes.

In step S602, in response to receiving the operation for displaying the portal screen by User A, the operation receiving unit 334 of the terminal apparatus 111 requests the management server 10 to display the portal screen.

In step S603, the receiving unit 302 of the management server 10 transmits the portal screen to the terminal apparatus 111 in response to the request from the terminal apparatus 111. In step S604, the display control unit 333 of the terminal apparatus 111 displays the portal screen.

In step S605, in response to selection by User A of a remote desktop connection on the portal screen, the communication system 1 performs processes of step S606 and subsequent steps. In the following description, the remote desktop connection may be referred to as “RDP connection.”

In step S606, the operation receiving unit 334 of the terminal apparatus 111 requests the management server 10 for a login screen for RDP connection.

In step S607, the receiving unit 302 of the management server 10 transmits the login screen for RDP connection to the terminal apparatus 111 in response to the request from the terminal apparatus 111. In step S608, the display control unit 333 of the terminal apparatus 111 displays a login screen that receives an input of login information for RDP connection. In the following description, the login information for RDP connection may be referred to as “PC login information.”

In step S609, when the user A enters the PC login information on the login screen, the communication system 1 performs processes of step S610 and subsequent steps.

In step S610, in response to receiving the input of the PC login information such as a user name, a password, and a domain, the operation receiving unit 334 of the terminal apparatus 111 transmits an RDP connection request including the received PC login information to the management server 10.

In step S611, the selection unit 303 of the management server 10 acquires a communication apparatus group that supports the remote desktop service of the connection destination. For example, the selection unit 303 refers to the connection destination list 313 as illustrated in FIG. 4C to acquire the group ID “BoxGroup_A” when the service of the connection destination is RDP connection to the “PC of User A.

In step S612, the selection unit 303 performs a communication apparatus selection processing of selecting a particular one communication apparatus 14 on which a lower load is placed from among multiple communication apparatus 14 included in the acquired communication apparatus group, i.e., the communication apparatus 14a whose apparatus ID is “Box_A01” and the communication apparatus 14b whose apparatus ID is “Box_A02.”

For example, the selection unit 303 refers to the group list 312 as illustrated in FIG. 4B to acquire the apparatus ID “Box_A01” and the apparatus ID “Box_A02” of the communication apparatuses 14 registered in association with the group ID “BoxGroup_A.” Further, the selection unit 303 refers to the apparatus list 311 as illustrated in FIG. 4A to acquire information of the communication apparatus “communication apparatus_network system A_1” associated with the apparatus ID “Box_A01.” In the following description, the communication apparatus “communication apparatus_network system A_1” associated with the apparatus ID “Box_A01” may be referred to as the “communication apparatus 14a.” In substantially the same manner, the selection unit 303 refers to the apparatus list 311 to acquire information of the communication apparatus “communication apparatus_network system A_2” associated with the apparatus ID “Box_A02.” In the following description, the communication apparatus “communication apparatus_network system A_2” associated with the apparatus ID “Box_A02” may be referred to as the “communication apparatus 14b.” Other examples of the communication apparatus selection processing performed by the selection unit 303 are described in embodiment below.

In step S613, the communication control unit 304 of the management server 10 generates a session ID for identifying a session. In another example, the communication control unit 304 may request the relay server 13 to generate the session ID, and the relay server 13 may generate the session ID.

In step S614, the communication control unit 304 of the management server 10 transmits, a connection instruction that instructs connection to the relay server 13 to the communication apparatus 14 (e.g., the communication apparatus 14a) selected in step S612. The connection instruction includes in the generated session ID.

In step S615, the relay unit 502 of the communication apparatus 14a transmits the connection request including the session ID notified from the management server 10 to the relay server 13 via the communication unit 501.

In step S616, the connection management unit 322 of the relay server 13 establishes a session with the communication apparatus 14a using the WSS.

In step S617, the relay unit 502 of the communication apparatus 14a notifies the management server 10 of a connection completion notification indicating that the communication apparatus 14a has connected to the relay server 13.

Following the operation described above with reference to FIG. 6, in step S701 of FIG. 7, the communication control unit 304 of the management server 10 transmits an instruction for connection to the relay server 13, including the session ID generated in step S613 of FIG. 6, to the terminal apparatus 111.

In step S702, the connection unit 332 of the terminal apparatus 111 transmits a connection request including the session ID notified from the application server 11 to the relay server 13 via the communication unit 331.

In step S703, the connection management unit 322 of the relay server 13 establishes a session of the WSS with the terminal apparatus 111. As a result, the terminal apparatus 111 and the communication apparatus 14a participate in the same session provided by the relay server 13 and exchange data with each other with the WSS.

In step S704 and step S705, the terminal apparatus 111 transmits, for example, the PC login information received in step S609 of FIG. 6 to the communication apparatus 14a via the relay server 13.

In step S706, the conversion unit 503 of the communication apparatus 14a performs protocol conversion on the PC login information received from the terminal apparatus 111 into the PC login information in RDP format.

In step S707, the conversion unit 503 of the communication apparatus 14 transmits the PC login information converted into the RDP format to the information processing apparatus 102. In the embodiment, it is assumed that the user of the terminal apparatus 111 is an authorized user of the remote desktop service provided by the information processing apparatus 102 and the login is successful.

In step S1708, the remote desktop service provided by the information processing apparatus 102 transmits information indicating that the login is successful and a remote desktop screen in the RDP format to the communication apparatus 14a.

In step S709, the relay unit 502 of the communication apparatus 14a transmits a connection success notification indicating that the connection is successful to the management server 10.

In step S710, the setting management unit 305 of the management server 10 updates the connection destination list 313 as illustrated in FIG. 4C on the basis of the connection success notification received from the communication apparatus 14a. For example, in the connection destination list 313, the setting management unit 305 updates the “status” associated with the connection destination ID “Dest01” to in use, updates the “user” to User A, updates the “communication apparatus in use” to the communication apparatus 14a, and updates the “latest usage date and time” to the current date and time.

In step S711, the conversion unit 503 of the communication apparatus 14a converts the remote desktop screen received from the information processing apparatus 102 into image data in a format displayable by the terminal apparatus 111.

In step S712 and step S713, the relay unit 502 of the communication apparatus 14a transmits the image data converted by the conversion unit 503 to the terminal apparatus 111 via the relay server 13.

Through the operation as described above, in step S714, User A can use the remote desktop service provided by the information processing apparatus 102 by using, for example, the web browser of the terminal apparatus 111.

After the operation described above with reference to FIG. 7, for example, in step S801 of FIG. 8, when the user performs a logout operation from the remote desktop service, the communication system 1 performs processing of step S802 and subsequent steps.

In step S802 and step S803, the terminal apparatus 111 transmits data of the logout operation by the user to the communication apparatus 14a via the relay server 13.

In step S804 and step S805, the conversion unit 503 of the communication apparatus 14a converts the data of the logout operation received from the terminal apparatus 111 into a logout operation in RDP format, and transmits the converted logout operation to the information processing apparatus 102.

In step S806, the remote desktop service provided by the information processing apparatus 102 transmits information indicating that the logout is successful to the communication apparatus 14a.

In step S807, the relay unit 502 of the communication apparatus 14a transmits a logout success notification indicating that the logout is successful to the management server 10.

In step S808, the setting management unit 305 of the management server 10 updates the connection destination list 313 as illustrated in FIG. 4C on the basis of the logout success notification received from the communication apparatus 14a. For example, in the connection destination list 313, the setting management unit 305 updates the “status” associated with the connection destination ID “Dest01” to available, deletes information of the “user” and the “communication apparatus in use”, and updates the “latest usage date and time” to the current date and time.

In step S809, the conversion unit 503 of the communication apparatus 14a converts the information indicating that the logout is successful received from the information processing apparatus 102 into a predetermined format as needed.

In step S810 and step S811, the relay unit 502 of the communication apparatus 14a transmits the information indicating that the logout is successful to the terminal apparatus 111 via the relay server 13.

In step S812, the connection unit 332 of the terminal apparatus 111 requests the relay server 13 to disconnect the session.

In step S813 and step S814, the connection management unit 322 of the relay server 13 disconnects the session with the communication apparatus 14a. In step S815, the connection management unit 322 disconnects the session with the terminal apparatus 111.

In step S816, the display control unit 333 of the terminal apparatus 111 displays, for example, a screen indicating that the logout is completed.

Through the operation as described above, in the communication system 1 according to the present embodiment, when the terminal apparatus 111 uses the remote desktop service provided by the information processing apparatus 102, the terminal apparatus 111 uses a particular one communication apparatus 14 on which a lower load is placed from among the communication apparatus 14a and the communication apparatus 14b that support the remote desktop service.

Although the description provided above with reference to FIG. 6 and FIG. 7 is of an example in which the number of the multiple communication apparatuses 14 that support the requested service is two, this is merely one example. In another example, the number of the multiple communication apparatuses 14 that support the requested service may be three or more.

Operation of Selecting Communication Apparatus

### First Embodiment

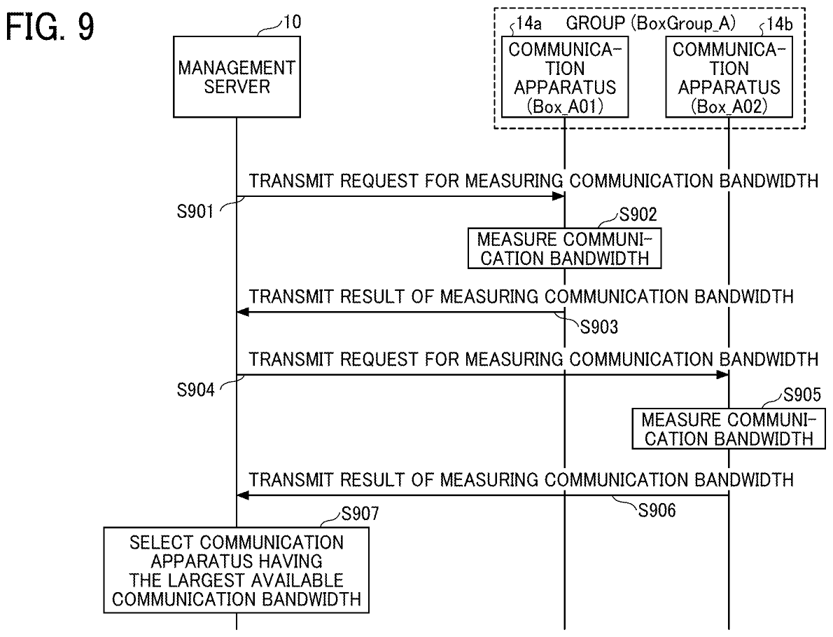

FIG. 9 is a sequence diagram illustrating an example of an operation of selecting a particular communication apparatus 14, according to a first embodiment. This operation is an example of the communication apparatus selection processing performed by the communication system 1 in step S612 of FIG. 6. In the following, a description is provided on the assumption that the communication apparatuses 14 that support a service requested by the terminal apparatus 111 are the communication apparatus 14a and the communication apparatus 14b.

In step S901, the selection unit 303 of the management server 10 transmits a request to measure communication bandwidth to the communication apparatus 14a.

In step S902 and step S903, the apparatus control unit 504 of the communication apparatus 14a measures, for example, communication bandwidth available to the communication apparatus 14a and transmits the measurement result to the management server 10.

In step S904, the selection unit 303 of the management server 10 transmits a request to measure communication bandwidth to the communication apparatus 14b.

In step S905 and step S906, the apparatus control unit 504 of the communication apparatus 14b measures, for example, communication bandwidth available to the communication apparatus 14b and transmits the measurement result to the management server 10. In a case that the communication system 1 includes three or more communication apparatuses 14 that support the service requested by the terminal apparatus 111, the selection unit 303 performs, for example, the same or substantially the same processes of steps S901 to S903 on each of the three or more communication apparatuses 14.

In step S907, the selection unit 303 selects the communication apparatus 14 having the largest spare capacity in the communication bandwidth from among the communication apparatus 14a and the communication apparatus 14b.

As described, the selection unit 303 may select particular one communication apparatus 14 on which a lower load is placed than the other communication apparatuses 14 from among multiple communication apparatuses 14 that support a service requested by the terminal apparatus 111 on the basis of the communication bandwidth available to each communication apparatus 14.

### Second Embodiment

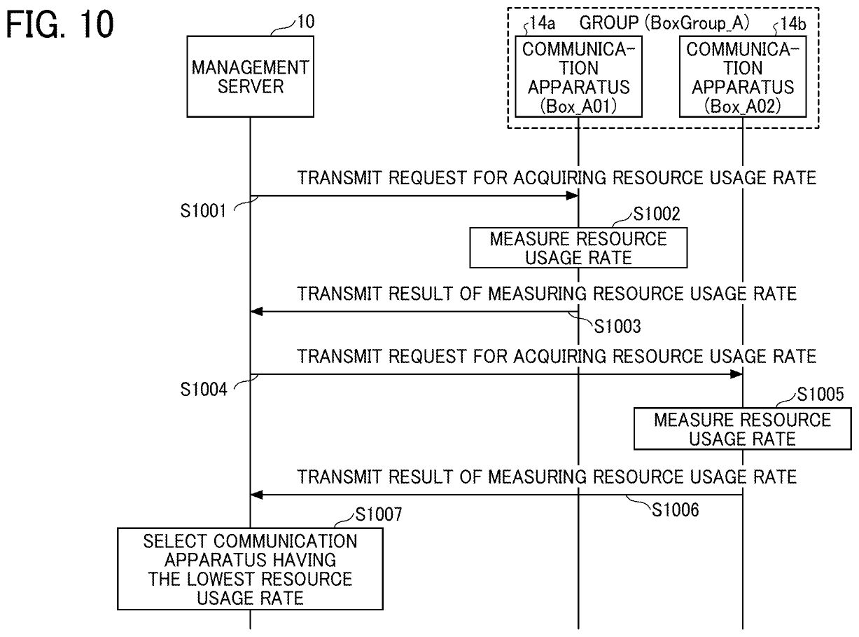

FIG. 10 is a sequence diagram illustrating an example of an operation of selecting a particular communication apparatus 14, according to a second embodiment.

This operation is another example of the communication apparatus selection processing performed by the communication system 1 in step S612 of FIG. 6. In the following, a description is provided on the assumption that the communication apparatuses 14 that support a service requested by the terminal apparatus 111 are the communication apparatus 14a and the communication apparatus 14b.

In step S1001, the selection unit 303 of the management server 10 transmits a request to measure a resource usage rate to the communication apparatus 14a.

In step S1002 and step S1003, the apparatus control unit 504 of the communication apparatus 14a measures, for example, a resource usage rate of the communication apparatus 14a and transmits the measurement result to the management server 10. For example, the apparatus control unit 504 measures, as the resource usage rate, one or more usage rates of a CPU usage rate and a memory usage rate.

In step S1004, the selection unit 303 of the management server 10 transmits a request to measure a resource usage rate to the communication apparatus 14b.

In step S1005 and step S1006, the apparatus control unit 504 of the communication apparatus 14b measures, for example, a resource usage rate of the communication apparatus 14b and transmits the measurement result to the management server 10. In a case that the communication system 1 includes three or more communication apparatuses 14 that support the service requested by the terminal apparatus 111, the selection unit 303 performs, for example, the same or substantially the same processes of steps S1001 to S1003 on each of the three or more communication apparatuses 14.

In step S1007, the selection unit 303 selects the communication apparatus 14 with the lowest resource usage rate from among the communication apparatus 14a and the communication apparatus 14b. For example, the selection unit 303 selects the communication apparatus 14 whose CPU usage rate is lowest from among the communication apparatus 14a and the communication apparatus 14b. Alternatively, the selection unit 303 may select the communication apparatus 14 whose memory usage rate is lowest from among the communication apparatus 14a and the communication apparatus 14b.

As described, the selection unit 303 may select particular one communication apparatus 14 on which a lower load is placed than the other communication apparatuses 14 from among multiple communication apparatuses 14 that support a service requested by the terminal apparatus 111 on the basis of, for example, the CPU usage rate or the memory usage rate of each communication apparatus 14.

The operation described above with reference to FIG. 10 is merely an example. In another example, the resource usage rate may include information such as a communication bandwidth, the number of established sessions, and throughput, and the selection unit 303 may select particular one communication apparatus 14 on which a lower load is placed than the other communication apparatuses 14 based on such the information.

### Third Embodiment

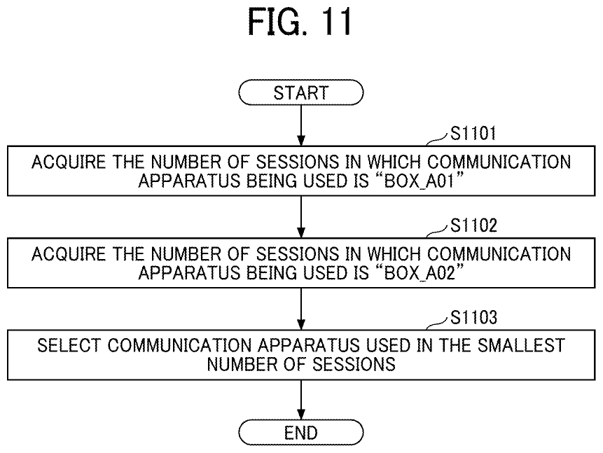

FIG. 11 is a flowchart illustrating an example of an operation of selecting a particular communication apparatus 14, according to a third embodiment. This operation is an example of the communication apparatus selection processing performed by the selection unit 303 of the management server 10 in step S612 of FIG. 6. In the following, a description is provided on the assumption that the communication apparatuses 14 that support a service requested by the terminal apparatus 111 are the communication apparatus 14a and the communication apparatus 14b.

In step S1101, the selection unit 303 refers to the connection destination list 313 as illustrated in FIG. 4C, to acquire the number of sessions for which the “communication apparatus in use” is the apparatus ID “Box_A01” identifying the communication apparatus 14a.

In step S1102, the selection unit 303 refers to the connection destination list 313 as illustrated in FIG. 4C, to acquire the number of sessions for which the “communication apparatus in use” is the apparatus ID “Box_A02” identifying the communication apparatus 14b. In a case that the communication system 1 includes three or more communication apparatuses 14 that support the service requested by the terminal apparatus 111, the selection unit 303 performs, for example, the same or substantially the same process of step S1101 on each of the three or more communication apparatuses 14.

In step S1103, the selection unit 303 selects particular one communication apparatus 14 for which the number of sessions in use is the smallest from among the communication apparatus 14a and the communication apparatus 14b.

As described, the selection unit 303 may select particular one communication apparatus 14 on which a lower load is placed than the other communication apparatuses 14 from among multiple communication apparatuses 14 that support a service requested by the terminal apparatus 111 on the basis of the number of sessions in use by each communication apparatus 14.

At least any two of the first to third embodiments can be combined. For example, the selection unit 303 may weight two or more values among the communication bandwidth, the resource usage rate, and the number of sessions of each communication apparatus 14. In this case, the selection unit 303 may select particular one communication apparatus 14 on which a lower load is placed than the other communication apparatuses 14 on the basis of, for example, the added or subtracted weights.

### Fourth Embodiment

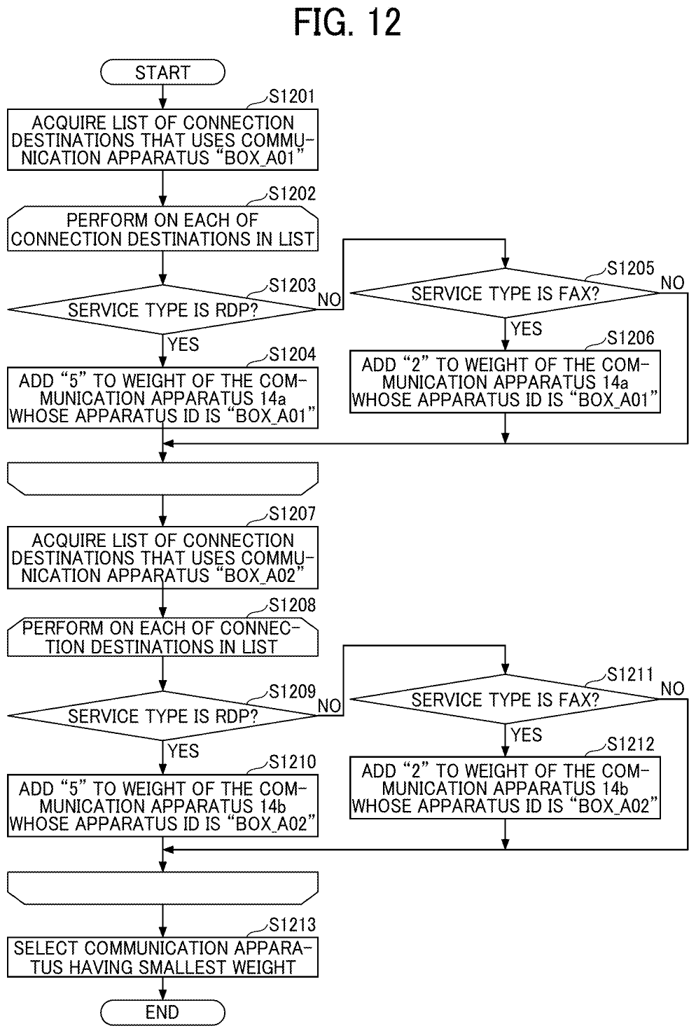

FIG. 12 is a flowchart illustrating an example of an operation of selecting a particular communication apparatus 14, according to a fourth embodiment. This operation is another example of the communication apparatus selection processing performed by the selection unit 303 of the management server 10 in step S612 of FIG. 6. In the following, a description is provided on the assumption that the communication apparatuses 14 that support a service requested by the terminal apparatus 111 are the communication apparatus 14a and the communication apparatus 14b.

In the fourth embodiment, a weight is added to the communication apparatus 14 according to the service type. In the example of FIG. 12, the weight “5” is added to the service type of “RDP,” and the weight “2” is added to the service type of “FAX”. The above values of weighting are merely examples, and any other suitable weighting value may be applied according to the service type.

In step S1201, the selection unit 303 refers to the connection destination list 313 as illustrated in FIG. 4C, to acquire a list of connection destinations associated with the apparatus ID “Box_A01” identifying the communication apparatus 14a in the “communication apparatus in use”.

In step S1202, the selection unit 303 performs processes of steps S1203 to S1206 for each of the connection destinations in the acquired list of connection destinations.

In step S1203, the selection unit 303 refers to the connection destination list 313, to determine whether the service type associated with the connection destination ID is “RDP.” When the selection unit 303 determines that the associated service type is RDP, the operation proceeds to step S1204. By contrast, when the selection unit 303 determines that the associated service type is not RDP, the operation proceeds to step S1205.

In step S1204, the selection unit 303 adds “5” to the weight of the communication apparatus 14a whose apparatus ID is “Box_A01.”

By contrast, when the operation proceeds from step S1203 to step S1205, the selection unit 303 refers to the connection destination list 313, to determine whether the service type associated with the connection destination ID is “FAX.” When the selection unit 303 determines that the associated service type is FAX, the operation proceeds to step S1206. By contrast, when the selection unit 303 determines that the associated service type is not FAX, the processes of steps S1203 to S1206 ends.

In step S1206, the selection unit 303 adds “2” to the weight of the communication apparatus 14a whose apparatus ID is “Box_A01.”

After the selection unit 303 performs the processes of steps S1203 to S1206 described above for each of the connection destinations in the list of connection destinations acquired in step S1201, the operation proceeds to step S1207.

In step S1207, the selection unit 303 refers to the connection destination list 313 as illustrated in FIG. 4C, to acquire a list of connection destinations associated with the apparatus ID “Box_A02” identifying the communication apparatus 14b in the “communication apparatus in use”.

In step S1208, the selection unit 303 performs processes of steps S1209 to S1212 for each of the connection destinations in the acquired list of connection destinations.

In step S1209, the selection unit 303 refers to the connection destination list 313, to determine whether the service type associated with the connection destination ID is “RDP.” When the selection unit 303 determines that the associated service type is RDP, the operation proceeds to step S1210. By contrast, when the selection unit 303 determines that the associated service type is not RDP, the operation proceeds to step S1211.

In step S1210, the selection unit 303 adds “5” to the weight of the communication apparatus 14b whose apparatus ID is “Box_A02.”

By contrast, when the operation proceeds from step S1209 to step S1211, the selection unit 303 refers to the connection destination list 313, to determine whether the service type associated with the connection destination ID is “FAX.” When the selection unit 303 determines that the associated service type is FAX, the operation proceeds to step S1219. By contrast, when the selection unit 303 determines that the associated service type is not FAX, the processes of steps S1203 to S1212 ends.

In step S1212, the selection unit 303 adds “2” to the weight of the communication apparatus 14b whose apparatus ID is “Box_A02.”

After the selection unit 303 performs the processes of steps S1209 to S1212 described above for each of the connection destinations in the list of connection destinations acquired in step S1207, the operation proceeds to step S1213.

In step S1213, the selection unit 303 selects particular one communication apparatus 14 having the smallest weight from among the communication apparatus 14a and the communication apparatus 14b.

As described, the selection unit 303 may select particular one communication apparatus 14 on which a lower load is placed than the other communication apparatuses 14 on the basis of the sum of the weights according to the usage of the sessions established by each of the communication apparatus 14a and the communication apparatus 14b.

### OTHER EMBODIMENTS

The operation of selecting a particular communication apparatus described above in each of the first to fourth embodiments is an example. For example, in response to the use request received by the receiving unit 302, the selection unit 303 may sequentially select one communication apparatus in a predetermined order from among the multiple communication apparatuses 14 (e.g., the communication apparatus 14a and the communication apparatus 14b) that support the requested service. Alternatively, in response to the use request received by the receiving unit 302, the selection unit 303 may randomly select one communication apparatus from among the multiple communication apparatuses 14 (e.g., the communication apparatus 14a and the communication apparatus 14b) that support the requested service.

Operation of Registering Communication Apparatus

A description is now given of an operation of registering the communication apparatus 14, according to the present embodiment.

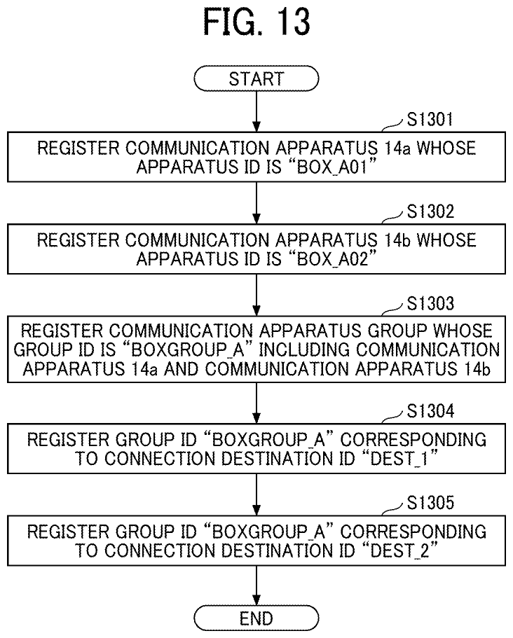

FIG. 13 is a flowchart illustrating an example of an operation of registering the communication apparatus 14, according to an embodiment. This operation is an example of an operation of registering, for example, the communication apparatus group 101 as illustrated in FIG. 1 in the communication system 1.

In step S1301, the setting management unit 305 of the management server 10 registers the communication apparatus 14a whose apparatus ID is “Box_A01” in the apparatus list 311 as illustrated in FIG. 4A. For example, the setting management unit 305 controls the management terminal 15 to display a registration screen for registering the communication apparatus 14. According to an input made by, for example, an administrator on the registration screen, the setting management unit 305 registers the apparatus ID “Box_A01” and the apparatus information “communication apparatus_network system A_first apparatus” in the apparatus list 311.

In step S1302, the setting management unit 305 registers the communication apparatus 14b whose apparatus ID is “Box_A02” in the apparatus list 311 as illustrated in FIG. 4A. For example, the setting management unit 305 controls the management terminal 15 to display the registration screen for registering the communication apparatus 14. According to an input made by, for example, an administrator on the registration screen, the setting management unit 305 registers the apparatus ID “Box_A02” and the apparatus information “communication apparatus_network system A_second apparatus” in the apparatus list 311.

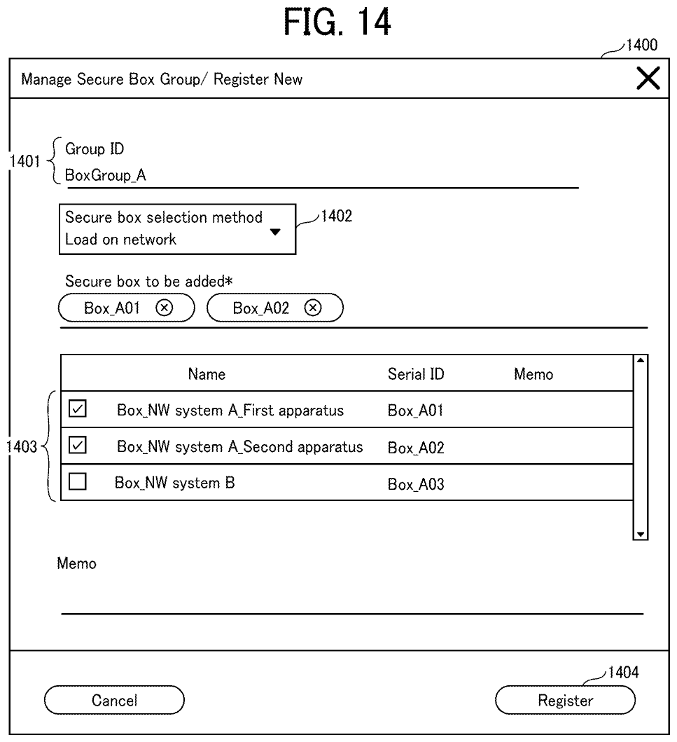

In step S1303, the setting management unit 305 registers the communication apparatus group 101 including the communication apparatus 14a and the communication apparatus 14b in the group list 312 as illustrated in FIG. 4B. For example, the setting management unit 305 controls the management terminal 15 to display a registration screen 1400 for registering a communication apparatus group as illustrated in FIG. 14. The setting management unit 305 receives a registration operation by, for example, an administrator through the registration screen 1400.

In the example of FIG. 14, a group ID input field 1401, a pull-down menu 1402, and a selection field 1403 are displayed on the registration screen 1400 for registering a communication apparatus group. From the pull-down menu 1402, a desired selection method of a secure box (communication apparatus 14) is selected. In the selection field 1403, a secure box to be added is selected.

The administrator or the like inputs a group ID of the communication apparatus group 101 to be newly registered in the group ID input field 1401. Further, the administrator or the like selects which selection operation is to be performed among the communication apparatus selection operations described in the first to fourth embodiments, for example, from the pull-down menu 1402 for selecting a desired selection method of the secure box (communication apparatus 14). Furthermore, the administrator or the like selects one or more secure boxes (the communication apparatus 14a and/or the communication apparatus 14b) to be added to the communication apparatus group 101 from the selection field 1403, and presses the “Register” button 1404. As a result, the setting management unit 305 registers the communication apparatus group 101 including the communication apparatus 14a and the communication apparatus 14b in the group list 312 as illustrated in FIG. 4B.

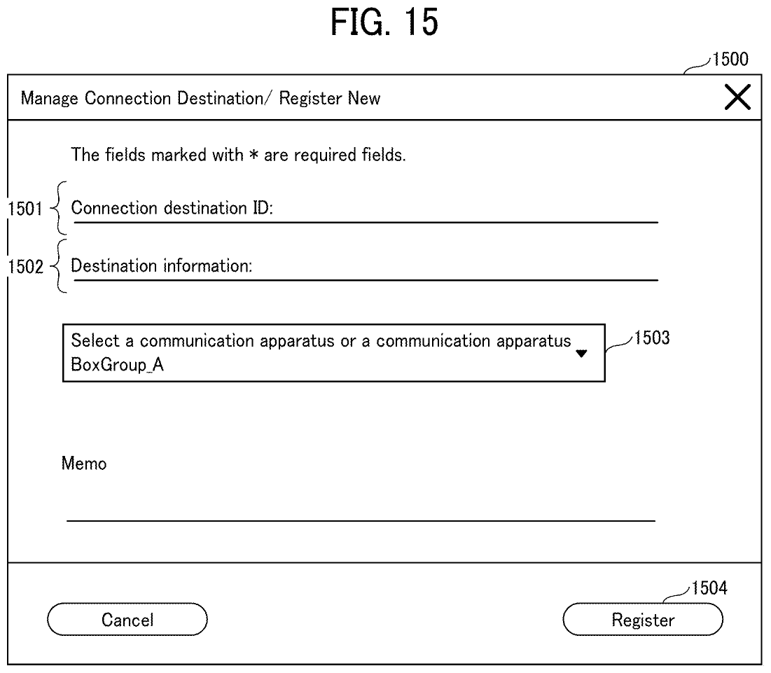

In step S1304, the setting management unit 305 registers the group ID “BoxGroup_A” associated with the connection destination ID “Dest01” in the connection destination list 313 as illustrated in FIG. 4C. For example, the setting management unit 305 controls the management terminal 15 to display a registration screen 1500 for registering a connection destination as illustrated in FIG. 15. The setting management unit 305 receives a registration operation by, for example, an administrator through the registration screen 1500.

In the example of FIG. 15, a connection destination ID input field 1501, a destination information input field 1502, and a pull-down menu 1503 are displayed on the registration screen 1500 for registering a connection destination. From the pull-down menu 1503, a desired communication apparatus or a desired communication apparatus group is selected.

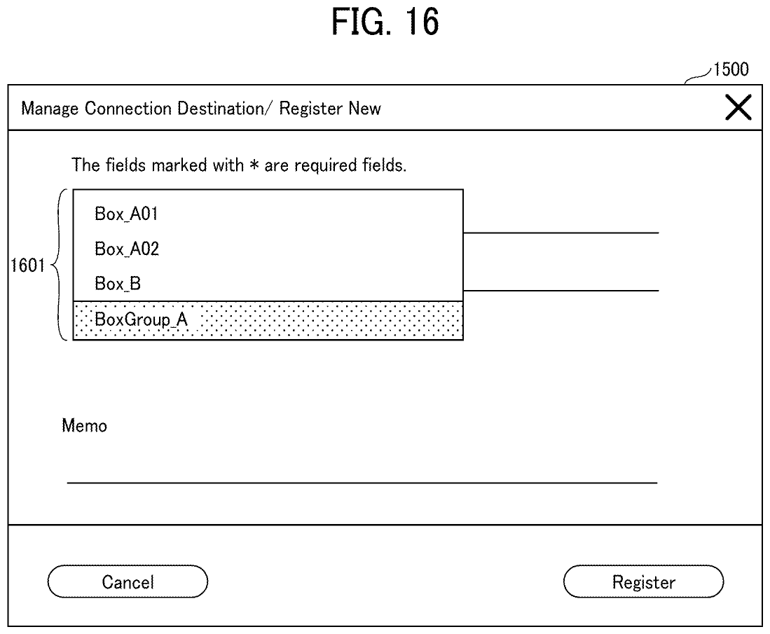

The administrator or the like inputs the connection destination ID of a connection destination to be newly registered in the connection destination ID input field 1501. Further, the administrator or the like inputs an IP address or the like of the information processing apparatus as the connection destination in the destination information input field 1502. Furthermore, the administrator or the like selects the group ID “BoxGroup_A” from the pull-down menu 1503 for selecting a desired communication apparatus or a desired communication apparatus group. For example, in response to an operation by the administrator or the like of pressing the pull-down menu 1503 for selecting a desired communication apparatus or a desired communication apparatus group, a list 1601 of the communication apparatuses and the communication apparatus groups registered in the communication system 1 is displayed as illustrated in FIG. 16. The administrator or the like selects the group ID “BoxGroup_A” from the list 1601 of the communication apparatuses and the communication apparatus groups, and presses the “Register” button 1504. As a result, the setting management unit 305 registers the group ID “BoxGroup_A” associated with the connection destination ID “Dest01” in the connection destination list 313 as illustrated in FIG. 4C.

In step S1305, the setting management unit 305 registers the group ID “BoxGroup_A” associated with the connection destination ID “Dest02” in the connection destination list 313 in the same or substantially the same manner as the process of step S1304.

Through the operation as described, the management server 10 stores the apparatus list 311 as illustrated in FIG. 4A, the group list 312 as illustrated in FIG. 4B, and the connection destination list 313 in, for example, the storage unit 306 and manages the stored lists.

As described above, according to each of the embodiments of the present disclosure, in the communication system 1 in which the terminal apparatus 111 connected to the external network uses a service provided by the information processing apparatus 102 in the local network 100, an increase in the number of users is efficiently handled.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The apparatuses or devices described in the above-described embodiments are merely examples of multiple computing environments that implement the above-described embodiments disclosed herein. In some embodiments, the management server 10 includes multiple computing devices, such as a server cluster.

The multiple computing devices are configured to communicate with one another through any type of communication link, including a network, a shared memory, etc., and perform the processes disclosed herein. In substantially the same manner, in some embodiments, the relay server 13 includes multiple computing devices that communicates with one another.

Further, the management server 10 and the relay server 13 can be configured to share the disclosed processes with any server in various combinations. For example, a process executed by a particular unit may be executed by the management server 10. In substantially the same manner, a function of a particular unit may be performed by the relay server 13. Further, the elements of the management server 10 and the relay server 13 are integrated into one apparatus or are divided into multiple apparatuses.

In communication systems of the related art, the quality is ensured by keeping the number of sessions in which remote access is used within a predetermined number. However, a case in which the number of users using remote access exceeds the predetermined number of sessions is not efficiently handled.

According to one or more embodiments of the present disclosure, in a communication system in which a terminal apparatus or the like connected to an external network uses a service provided by an information processing apparatus in a local network, an increase in the number of users is efficiently handled.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A communication system comprising circuitry configured to:
receive a use request for using a service provided by an information processing apparatus that resides in a local network, from a terminal apparatus connected to an external network external to the local network;
according to the use request, select, from among multiple communication apparatuses that reside on the local network and support the service, particular one communication apparatus having a lower load than other communication apparatuses; and
instruct the terminal apparatus and the particular one communication apparatus to each connect to a relay server on the external network.

2. The communication system of claim 1, wherein
the circuitry is further configured to notify the terminal apparatus and the particular one communication apparatus of identification information,
the relay server relays communication between the terminal apparatus and the particular one communication apparatus, each being connected to the relay server, by using the identification information, and
the communication apparatus relays communication between the relay server and the service.

3. The communication system of claim 1, wherein the communication system includes:
a management server that includes the circuitry and is connected to the external network;
the multiple communication apparatuses connected to the local network; and
the relay server connected to the external network.

4. The communication system of claim 1, wherein
the circuitry selects the particular one communication apparatus according to information on a resource in use or available by each of the multiple communication apparatuses.

5. The communication system of claim 4, wherein the information on the resource includes one or more of a communication bandwidth of the communication apparatus, a number of sessions established by the communication apparatus, a usage rate of a processor of the communication apparatus, and a usage rate of a memory of the communication apparatus.

6. The communication system of claim 1, wherein the circuitry selects the particular one communication apparatus based on a sum of weights based on usage of sessions established by each of the multiple communication apparatuses.

7. The communication system of claim 1, wherein the circuitry is further configured to provide an information terminal with a setting screen for registering the multiple communication apparatuses that support the service as a group.

8. A management server, comprising circuitry configured to:
receive, from a terminal apparatus connected to an external network external to a local network, a use request for using a service provided by an information processing apparatus that resides in the local network, the service being used by the terminal apparatus via a communication apparatus that resides in the local network;
according to the use request, select, from among multiple communication apparatuses that reside on the local network and support the service, particular one communication apparatus having a lower load than other communication apparatuses; and
instruct the terminal apparatus and the particular one communication apparatus to each connect to a relay server on the external network.

9. A non-transitory computer-executable medium storing a program storing instructions which, when executed by one or more processors of a computer that controls communication, causes the one or more processors to perform a method comprising:
receiving, from a terminal apparatus connected to an external network external to a local network, a use request for using a service provided by an information processing apparatus that resides in the local network, the service being used by the terminal apparatus via a communication apparatus that resides in the local network;
according to the use request, selecting, from among multiple communication apparatuses that reside on the local network and support the service, particular one communication apparatus having a lower load than other communication apparatuses; and
instructing the terminal apparatus and the particular one communication apparatus to each connect to a relay server on the external network.
